(19) United States
(12) Patent Application Publication
(10) Pub. No.: US 2004/0049415 A1
(43) Pub. Date: Mar. 11, 2004

(54) System and method for rescheduling procurement according to altered demand

(76) Inventors: Kan-Lee Liou, Tu-chen (TW); ZhiBiao Xiao, Shenzhen (CN); Tzung-Lin Wu, Tu-chen (TW); Qing Li, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/335,305

(22) Filed: Dec. 30, 2002

(30) Foreign Application Priority Data
Sep. 11, 2002 (TW) 91120666

(51) Int. Cl. G06F 17/60

(52) U.S. Cl. 705/7

(57) ABSTRACT

A procurement rescheduling system (20) includes a production planning module (30) for scheduling production and generating production scheduling sheets (102) according to received purchase order modifications (100); a material management module (31) for managing inventory data and bill of material data stored in a database (33); and a procurement rescheduling module (32) for rescheduling material procurement according to the production scheduling sheets. The procurement rescheduling module includes a time span management submodule (321) for managing procurement time spans for different materials, a demand calculation submodule (322) for calculating revised demand for materials in each procurement time span, a delivery date calculation submodule (323) for calculating delivery dates for materials procurement according to the production scheduling sheets, and a material purchase order generating submodule (324) for automatically generating revised material purchase orders. A related method for rescheduling material procurement according to altered demand is also disclosed.

### BACKGROUND OF THE INVENTION

1. Field of the Invention

This invention relates to systems and methods for rescheduling procurement according to altered demand, and more particularly to systems and methods which automatically calculate demand for material in preset procurement time spans and generate new material purchase orders according to the calculated demand for material.

2. Description of Related Art

Most large manufacturing enterprises employ a material requirement planning (MRP) system to manage their material requirements and material procurement. Many popular ERP systems on the market provide functional modules needed for MRP. Such systems include SAP R/3 from SAP, SyteLine from Symix computer system Inc., and so on. Such MRP systems help enterprises collect material requirement data and schedule material procurement in time.

With the numerous diversification of business transactions, purchase orders released by customers are frequently modified or canceled according to new market demand. When a purchase order from a customer is modified, a corresponding material procurement schedule must be modified accordingly. However, most existing MRP systems cannot efficiently handle the problems raised by material procurement rescheduling. For example, when modifying a material procurement order, the MRP module of SAP R/3 only provides the functions of either resetting or canceling a delivery date of the material procurement order. If only a part of the material procurement order needs to be canceled or if the material procurement order is divided into several new material procurement orders, SAP R/3 cannot satisfactorily handle such matters.

Accordingly, what is needed is a system and method which can overcome the abovementioned problems.

### SUMMARY OF THE INVENTION

A primary object of the present invention is to provide a system which automatically calculates demand for material in preset procurement time spans and generates new material purchase orders according to the calculated demand for material and according to supply.

Another object of the present invention is to provide a method which automatically calculates demand for material in preset procurement time spans and generates new material purchase orders according to the calculated demand for material and according to supply.

To achieve the above-mentioned primary object, a system of the present invention for rescheduling material procurement comprises: a production planning module for scheduling production and generating production scheduling sheets according to received purchase order modifications; a material management module for managing inventory data and bill of material data stored in a database; and a procurement rescheduling module for rescheduling material procurement according to the production scheduling sheets. The procurement rescheduling module comprises a time span management submodule for managing procurement time spans for different materials, a demand calculation submodule for calculating revised demand for materials in each procurement time span, a delivery date calculation submodule for calculating delivery dates for materials procurement according to the production scheduling sheets, and a material purchase order generating submodule for automatically generating revised material purchase orders.

To achieve the other above-mentioned object, a method of the present invention for rescheduling material procurement comprises the following steps: receiving a purchase order modification from a customer; calculating a total demand for material for a plurality of preset procurement time spans; calculating a balance of material according to the total demand for material and supply of material; determining a delivery date for material required for each procurement time span; and generating and sending out a revised material purchase order.

Other objects, advantages and novel features of the present invention will be drawn from the following detailed description of a preferred embodiment of the present invention with attached drawings, in which:

### BRIEF DESCRIPTION OF THE DRAWINGS

FIG. 1 is a schematic diagram showing structure and data interchange of a procurement rescheduling system in accordance with the preferred embodiment of the present invention;

FIG. 2 is a schematic diagram of main function submodules of a procurement rescheduling module of the procurement rescheduling system of FIG. 1;

FIG. 3 is flowchart of a method for implementing the procurement rescheduling system of FIG. 1; and

FIGS. 4 through 7 are exemplary tables generated in relation to a process for rescheduling a material purchase order according to the method for implementing the procurement rescheduling system as disclosed in FIG. 3.

### DETAILED DESCRIPTION OF THE INVENTION

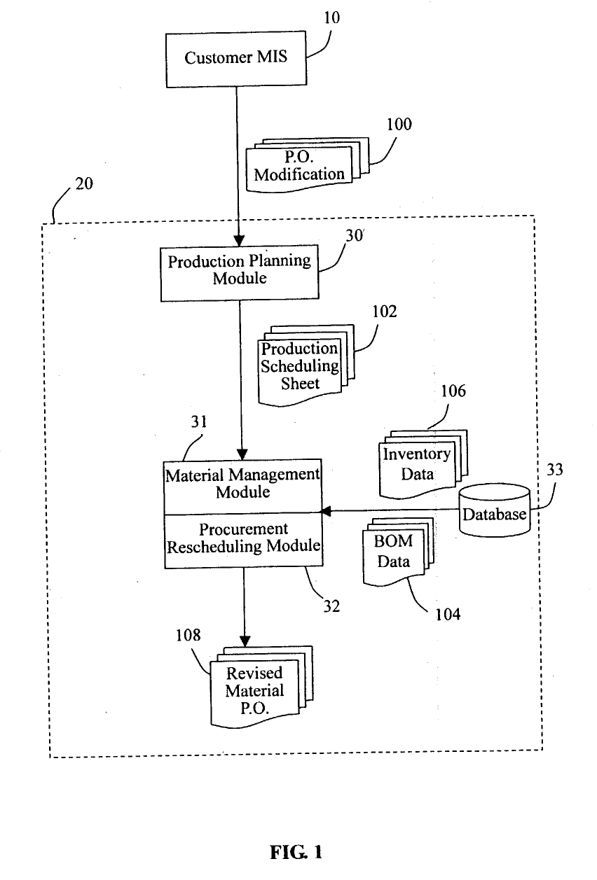

FIG. 1 is a schematic diagram showing structure and data interchange of a procurement rescheduling system 20 in accordance with a preferred embodiment of the present invention. The procurement rescheduling system 20 comprises a production planning module 30, a material management module 31, a procurement rescheduling module 32, and a database 33. A client management information system (MIS) 10 electronically connects to the procurement rescheduling system 20, and sends purchase order (P.O.) modifications 100 to the production planning module 30 via a network (not labeled). Each purchase order modification 100 is for modifying a purchase order previously released.

The production planning module 30 is for receiving the purchase order modifications 100 sent by customers, and generating production rescheduling sheets 102 according the received purchase order modifications 100. The production rescheduling sheets 102 are sent to the material management module 31, which then retrieves inventory data 106 and bill of material (BOM) data 104 stored in the database 33 according to the production scheduling sheets 102. The procurement rescheduling module 32 reschedules material procurement according to the production rescheduling sheets 102 and inventory data 106, and sends out revised material purchase orders 108.

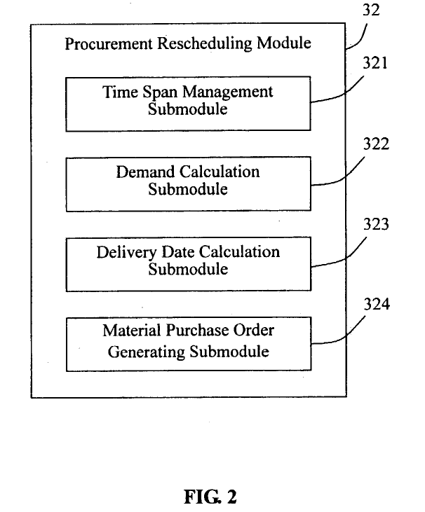

FIG. 2 is a schematic diagram of main function submodules of the procurement rescheduling module 32 of the procurement rescheduling system 20. The procurement rescheduling module 32 comprises a time span management submodule 321, a demand calculation submodule 322, a delivery date calculation submodule 323, and a material purchase order generating submodule 324.

The time span management submodule 321 defines time spans in which required materials are to be procured. Different materials have different time spans for procurement. Each material has a standard procurement time span, on which an actual time span for procurement is based. For example, an important and expensive material may have a standard procurement time span of 10 days, and a common material with a lower unit price may have a standard procurement time span of 30 days.

The demand calculation submodule 322 recalculates demand for materials according to purchase order modifications 100 and inventory data 106. For example, a purchase order previously released by a customer may be divided into several new purchase orders, or may be modified as to quantity or delivery date. The demands for materials in various actual time spans are modified in accordance with the purchase order modifications 100.

The delivery date calculation submodule 323 recalculates material delivery dates according to purchase order modifications 100. Generally, there is a lead time for material procurement before a purchase order is released to production departments for production. The material delivery dates are determined by the lead times and production schedules of corresponding purchase orders.

The material purchase order generating submodule 304 is for generating revised material purchase orders 108 according to purchase order modifications 100 released by customers.

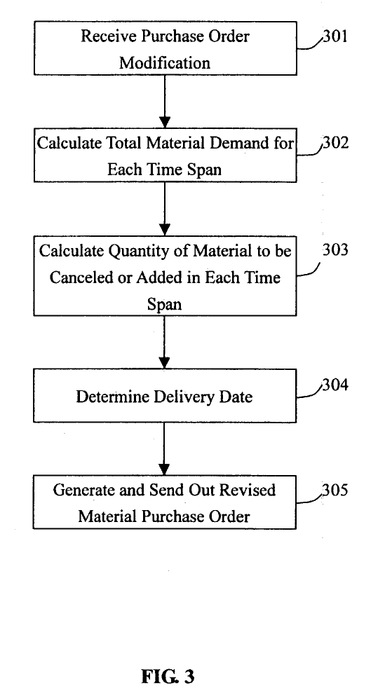

FIG. 3 is flowchart of a method for implementing the procurement rescheduling system 20 according to the preferred embodiment of the present invention. In step 301, the procurement rescheduling system 20 receives a purchase order modification 100 sent from a customer. The production planning module 30 reschedules production according to the purchase order modification 100, and sends a production scheduling sheet 102 to the material management module 31 and the procurement rescheduling module 32.

In step 302, the procurement rescheduling module 32 compiles demands for materials covering various actual time spans, according to the production scheduling sheet 102. The actual time spans for each material are different from the actual time spans for other materials, and each actual time span starts on a day that a material is ordered. For example, a material “A” has a standard procurement time span of 30 days, and is required as follows: 1000 pieces on September 5^{th}, 500 pieces on September 10^{th}, 2000 pieces on November 15^{th}, and 1000 pieces on November 30^{th}. The procurement rescheduling module 32 defines a first actual time span from September 5^{th} to October 5^{th}, and a second actual time span from November 15^{th} to December 15^{th}. In the first actual time span, the demand for material “A” is 1500 pieces (1000 pieces on September 5^{th} and 500 pieces on September 10^{th}). Similarly, in the second actual time span, the demand for material “A” is 3000 pieces (2000 pieces on November 15^{th}, and 1000 pieces on November 30^{th}).

In step 303, the procurement rescheduling module 32 calculates a quantity of material to be canceled or added in each actual time span. When a purchase order released by a customer is modified, the corresponding material purchase order is modified accordingly. For example, if a modified demand for material “A” is 1000 pieces, and 2000 pieces of material “A” are ordered by an original material purchase order in a same actual time span, the procurement rescheduling module 32 cancels 1000 pieces of material “A” in a revised material purchase order 108 for that actual time span. Similarly, if the original material purchase order is insufficient to meet the modified demand for material for that actual time span, the procurement rescheduling module 32 adds to the demand for material in the corresponding revised material purchase order 108.

In step 304, the delivery date of material procurement is determined. The delivery date of material procurement is calculated according to production schedules of the purchase order modification sent by the customer. Lead time and off days are also taken into consideration when determining the delivery date. For example, if a material “A” is required on September 10^{th}, the lead time is 3 days and the off days are 2 days, and so the delivery date of material “A” is set at September 5^{th}.

In step 305, the procurement rescheduling module 32 generates a revised material purchase order 108, and sends the revised material purchase order 108 to one or more relevant suppliers.

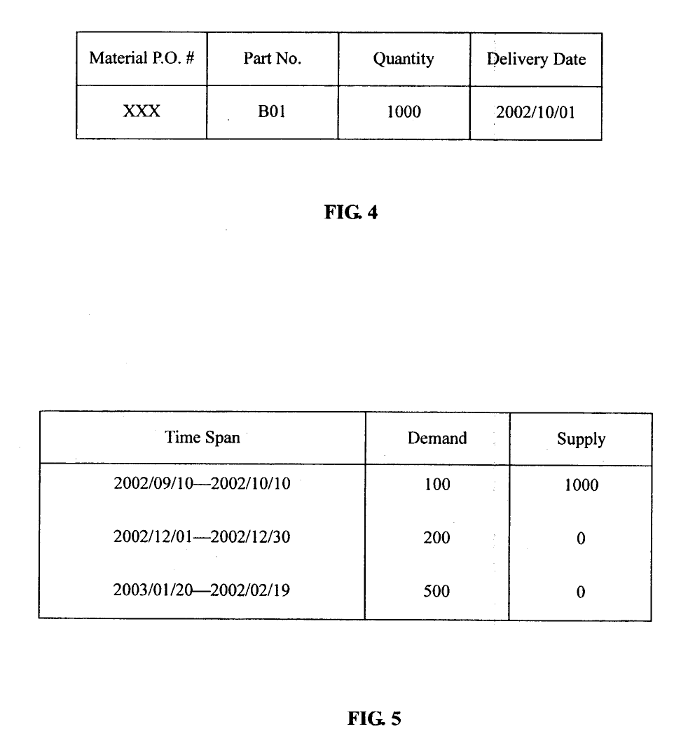

FIGS. 4 through 7 are exemplary tables generated in relation to a process for rescheduling a material purchase order according to the method for implementing the procurement rescheduling system as disclosed in FIG. 3. Referring to FIG. 4, an original material purchase order no. XXX orders 1000 pieces of material having part no. B01. The delivery date is Oct. 1^{st} 2002. The standard procurement time span of the material is 30 days. No inventory of the material is on hand.

Referring to FIG. 5, the customer's purchase order is modified, and the demand for material becomes: 100 pieces on Sep. 10^{th} 2002, 200 pieces on Dec. 1^{st} 2002, and 500 pieces on Jan. 20^{th} 2003. The procurement rescheduling module 32 recalculates material demand and material supply in each actual time span according to the customer's purchase order modification 100 and the original material purchase order. In the first actual time span, from Sep. 10^{th} 2002 to Oct. 10^{th} 2002, the material demand is 100 pieces and the supply is 1000 pieces (from the original material purchase order having the delivery date of Oct. 1^{st} 2002). In the second actual time span, from Dec. 1^{st} 2002 to Dec. 30^{th} 2002, the material demand is 200 pieces and the supply is 0. In the third actual time span, from Jan. 20^{th} 2003 to Feb. 19^{th} 2003, the material demand is 500 pieces and the supply is 0.

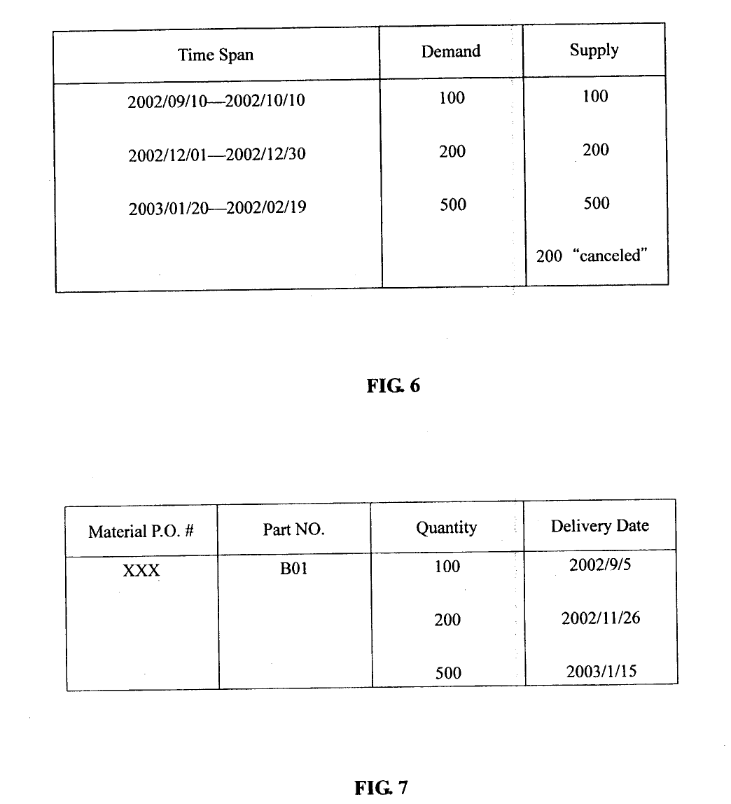

Referring to FIG. 6, the original material purchase order is modified to meet actual demand for material. The 1000 pieces of material ordered by the original material purchase order are apportioned into the three actual time spans in accordance with the demand of each actual time span. The net surplus 200 pieces are canceled.

FIG. 7 shows the content of the corresponding revised material purchase order 108. The delivery dates are determined according to the first day of each actual time span, brought forward by lead time and off days that need to be taken into consideration. As shown, the first actual time span is from Sep. 10^{th} 2002 to Oct. 10^{th} 2002. The lead time and off days are respectively 3 days and 2 days, a total of 5 days. Accordingly, the delivery date of the material required for the first actual time span is Sep. 5^{th} 2002.

The preferred embodiment described herein is merely illustrative of the principles of the present invention. Other arrangements and advantages may be devised by those skilled in the art without departing from the spirit and scope of the present invention. Accordingly, the present invention should be deemed not to be limited to the above detailed description, but rather by the spirit and scope of the claims which follow and their equivalents.

What is claimed is:

1. A system for rescheduling material procurement according to altered demand, the system comprising:
a production planning module for scheduling production and generating production scheduling sheets; and
a procurement rescheduling module for rescheduling material procurement according to the production scheduling sheets, the procurement rescheduling module comprising:
a time span management submodule for managing procurement time spans for different materials,
a demand calculation submodule for calculating revised demand for materials in each procurement time span,
a delivery date calculation submodule for calculating delivery dates for materials procurement according to the production scheduling sheets, and
a material purchase order generating submodule for automatically generating material purchase orders.

2. The system as claimed in claim 1, further comprising a database that stores inventory data and bill of material data.

3. The system as claimed in claim 2, further comprising a material management module for managing inventory data and bill of material data stored in the database.

4. A method for rescheduling material procurement according to altered demand, the method comprising the following steps:
receiving a purchase order modification from a customer;
calculating a total demand for material for at least one preset procurement time span;
calculating a balance of material according to the total demand for material and supply of material;
determining at least one delivery date for material required for the at least one procurement time span; and
generating and sending out a material purchase order.

5. The method as claimed in claim 4, further comprising the step of:
rescheduling production and generating a production scheduling sheet according to the purchase order modification.

6. The method as claimed in claim 4, wherein there is a plurality of procurement time spans, and the procurement time spans vary according to the material required.

7. The method as claimed in claim 4, wherein the supply of material comprises material provided according to an original purchase order and available inventory.

8. A method of material procurement arrangement comprising:
receiving an initial product purchase order from a customer;
arranging an initial material purchase order for at least one preset procurement time span;
receiving a modified product order from the customer;
calculating a total demand for material for said time span;
calculating a balance of material according to the total demand for material and supply of material;
determining at least one delivery date for material required for said time span; and
generating and sending out a modified material purchase order.
